(19) United States
(12) Patent Application Publication
(10) Pub. No.: US 2023/0115429 A1
(43) Pub. Date: Apr. 13, 2023

(54) Picsee Selfie Mirror

(71) Applicant: Nakinja Kaabah Gaither, Washington, DC (US)

(72) Inventor: Nakinja Kaabah Gaither, Washington, DC (US)

(21) Appl. No.: 17/495,835

(22) Filed: Oct. 7, 2021

(51) Int. Cl. A47G 1/02; H04W 4/80; G06F 3/04886

(52) U.S. Cl. CPC A47G 1/02; H04W 4/80; G06F 3/04886

(57) ABSTRACT

The present invention relates to a selfie mirror which eliminates the need for the user to have to take an image or video via the reflection of the mirror, rather a camera device will be able to take an image and/or video from the point of view of the mirror, without the need of the mirror reflection. The proposed assembly provides a mirror with button enabled timer to take image or series of images. The proposed assembly also supports video mode. The assembly can be activated through button and allows seamless transfer to any external device using Bluetooth, wi-fi connections or QR code. It further allows to display the comments on mirror received on the image.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present disclosure relates, in general, to a mirror, and more specifically, to a selfie mirror with built in camera to take images and form videos.

### Description of the Related Art

The rapid proliferation of mobile phones equipped with one or more cameras, together with the widespread use of social media, has given rise to the “selfie”-a photograph taken by oneself of oneself. Selfies are often taken with either the forward-facing or the backward-facing camera of a mobile phone. When the forward-facing camera is used, the screen of the mobile phone is visible to the user and serves as a viewfinder, allowing the user to adjust the position of the mobile phone to capture the desired photograph. When the backward-facing camera is used, the screen of the mobile phone is not visible to the user, such that the user can only point and shoot, using trial and error to obtain the desired photograph. Selfie sticks-extendible poles, to one end of which a mobile phone or other camera may be attached—have gained popularity as an accessory for taking selfies, as they allow the mobile phone (or other camera) to be held at greater than arm's length from the user, and thus allow the user to capture a wider field of view in the selfie.

Because the camera and the flash light are usually located on the back of a smartphone, and on smartphones that also have a front camera the rear camera is usually much better, selfie mirrors are used in order to achieve a better orientation of the smartphone without looking at the screen when taking pictures.

Self-adhesive mirrors that can be attached to the smartphone, as well as smartphone sleeves with selfie mirrors already attached to them, as well as selfie mirrors that may be attached to a selfie stick or plugged onto the edge of a smartphone for use, are already known in prior art (see document U.S. Pat. No. 8,573,395).

There are multiple inventions that have been proposed in prior art regarding bringing an advancement and enhanced utility regarding advancements in selfie devices. Furthermore, the utilization of these systems in daily life are quite cumbersome and non-effective. Also, the features of these utility system are quite limited.

In contrast, it is an object of the invention to create a selfie mirror with additional benefits. This object is achieved according to the invention by the arrangement of a mirror with a built in or external device; camera to take images & videos of subject(s) or object(s) in front of mirror. The proposed assembly will eliminate the need for the user to have to take an image or video via the reflection of the mirror, rather a camera device will be able to take an image and/or video from the point of view of the mirror, without the need of the mirror reflection. It also provides additional advancements which haven't been seen in prior art.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention seeks to improve devices for an advancement in selfie taking devices.

It is the object of present invention to provide a device which provides sleek mirror with a built in or external device; camera to take images and videos of subject(s) or object(s) in front of mirror.

It is a more particular object of the present invention to provide an improved system which eliminates the need for the user to have to take an image or video via the reflection of the mirror, rather a camera device will be able to take an image and/or video from the point of view of the mirror, without the need of the mirror reflection.

It is also the objective of invention to provide mirror which will have a stylish cabinet with built-in, adjustable LED lights with diffusers, and a camera at eye-level behind the glass.

It is an object of the present invention to provide an image mode where single or multiple image/s can be taken and user can post photos and video to phone or share directly from the display.

It is another object of the present invention to provide a video mode can also be enabled to record video of participant(s) or object(s).

It is a further object of the present invention to display notifications and info on the touchscreen mirror display.

It is also the objective of the invention, to provide Bluetooth and QR code capability to seamlessly transfer the images or video taken to the chosen device of the subject.

It is also the objective of the invention to provide an associated application which also assist in the transfer of assets from mirror device camera to user device. The device also has additional editing, storage, and sharing features & capabilities.

It is further the objective of invention to provide a mirror which can be stand alone, leaned against an object or hung on a wall, i.e. bedroom and/or bathroom mirror.

Thus, it is the objective to provide a new and improved form of an advancement in taking mirror selfies. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates perspective use of proposed assembly, in accordance with an embodiment of the present disclosure.

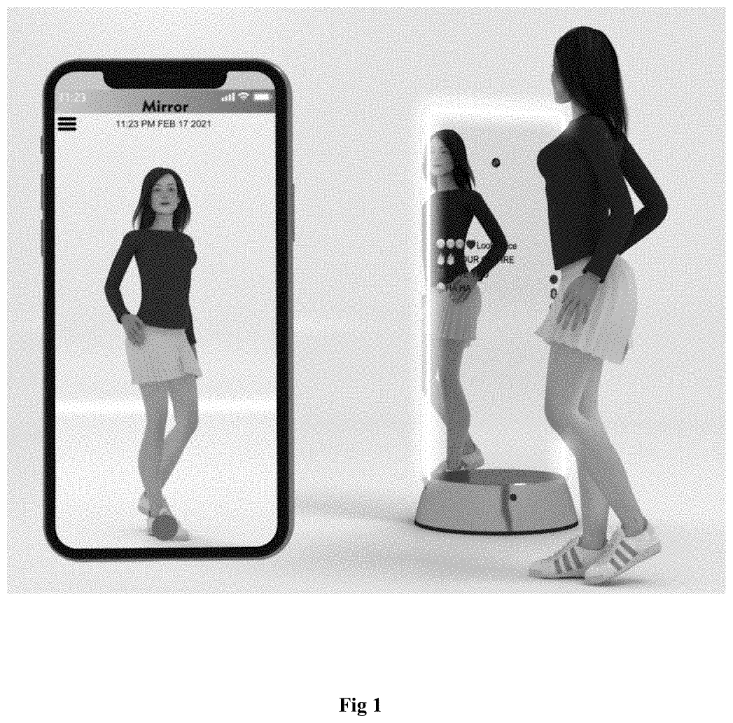

FIG. 2 illustrates installed view, in accordance with an embodiment of the present disclosure.

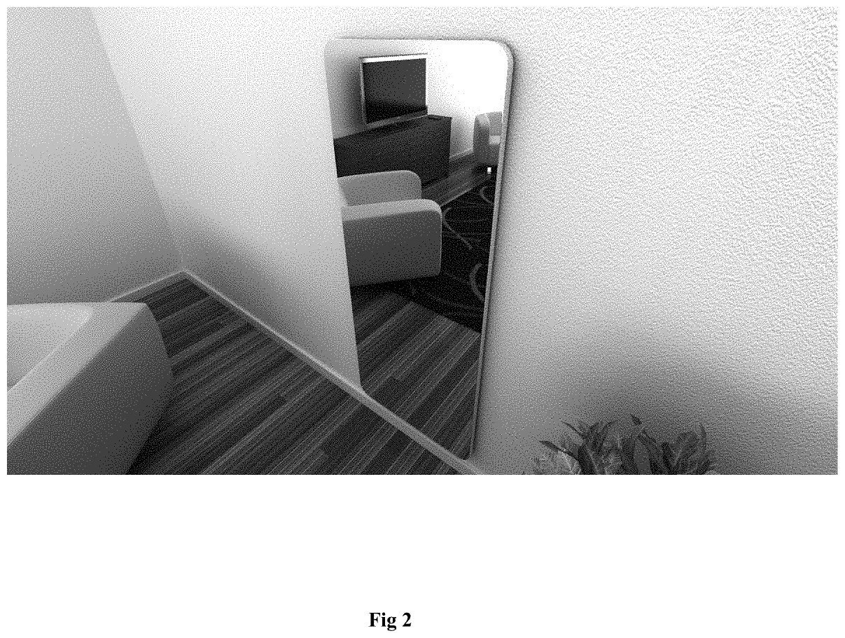

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention provides an advancement in selfie mirror device which is not seen in prior art.

A smart mirror for taking selfies according to another embodiment of the present disclosure includes a base; a mirror adjustably attached to the support; a camera positioned adjacent the mirror; an LED light source; and a user interface for operating the camera and the LED light source. The smart mirror of claim may further comprise a wireless transceiver; a processor; and a memory, the memory storing instructions for execution by the processor that, when executed, cause the processor to establish a connection via the wireless transceiver. The memory may store additional instructions for execution by the processor that, when executed by the processor, cause the processor to receive, via the wireless transceiver, a command; and execute the command. The command may be one of a command to activate the camera or a command to adjust one of an intensity and a wavelength of light outputted by the LED light source. In some embodiments, the mirror can be panned, tilted, swiveled, and rotated relative to the base. The LED lighting source may at least partially surround the mirror. The memory may also store additional instructions for execution by the processor that, when executed by the processor, cause the processor to transmit, via the wireless transceiver, data corresponding to at least one image captured by the camera.

The mirror device as per its additional embodiments allows built-in display, high quality diffused lighting, and camera, you can ensure you get the perfect shot with no phone in sight. The proposed assembly allows to take more natural, higher quality photos and videos without having user's hand up or phone in the way.

The mirror device as per its additional embodiments features a stylish cabinet with built-in, adjustable LED lights with diffusers, and a camera at eye-level behind the glass. The display is partially silvered for a reflective surface that won't block your shot while allowing you to express and emote without needing another pair of hands. The assembly also allows to share directly from the display, or forward photos to your phone for viewing, editing and posting.

The mirror device as per its further embodiments allows the selfie mirror to create a Bluetooth connection to scan QR code to seamlessly transfer the images or video taken to the chosen device of the subject.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1: A selfie mirror comprising:
a housing connected to a support via a mount;
a mirror supported by the housing, the mirror having an outer perimeter;
a camera fixedly positioned within the housing outside of and adjacent to the outer perimeter;
a lighting source substantially surrounding the outer perimeter, wherein the lighting source is capable of serving as a flash for the camera and enhanced lightning installed within stylish cabinet;
a user interface;
a button for an internal timer;
a video mode to enable videos;
a physical button to turn the camera on/off;
a shutter button or take photos on a timer;
a wireless transceiver in term of Bluetooth, Wi-Fi or QR Code;
a built-in light ring under the glass; and
a memory, the memory storing instructions for execution by the processor that, when executed, cause the processor to:
receive a command to activate the camera from the user interface or the wireless transceiver; and
activate the camera.

2. The selfie mirror of claim 1, wherein activating the camera comprises one of taking a photograph and recording a video.

3. The selfie mirror of claim 1, wherein the memory stores additional instructions for execution by the processor that, when executed, further cause the processor to:
receive a command, via the wireless transceiver, to cause the camera to zoom in or out.

4. The selfie mirror of claim 1, wherein the memory stores additional instructions for execution by the processor that, when executed further cause the processor to:
establish, via the wireless transceiver, a wireless connection with a cloud; and
upload at least one of a photographs and a video; and,
displaying comments on the selfie mirror.
